(19) United States
(12) Patent Application Publication
(10) Pub. No.: US 2015/0012840 A1
(43) Pub. Date: Jan. 8, 2015

(54) Identification and Sharing of Selections within Streaming Content

(71) Applicant: International Business Machines Corporation, Armonk, NY (US)

(72) Inventors: Mario Alessandro Maldari, Durham, NC (US); Bhavin H. Shah, Durham, NC (US); Anuradha Ramamoorthy, Durham, NC (US)

(21) Appl. No.: 13/933,939

(22) Filed: Jul. 2, 2013

(51) Int. Cl. H04L 29/06

(52) U.S. Cl. CPC H04L 65/60
USPC 715/748

(57) ABSTRACT

A tool for identifying selections of streaming content such as video, movies, and audio, establishes connections to an input device (stylus, mouse, trackball, a touch screen, etc.) and an output device (smart television, computer screen, etc.) or a streaming content server (on-demand server, cable TV decoder, online radio station, etc.). A user selects a portion of the streaming content such as by tapping or circling a person, place or thing in a video, using the input device, and the selection criteria are used to look up pre-tagged content or to submit to image or audio recognition services. The resulting identification is shown to the user on an output device, and may be instantly shared with collaborators on the same streaming content.

### FIELD OF THE INVENTION

This invention relates to systems and methods identifying selected subjects in streaming content, and sharing that identification contemporaneously or persistently.

### BACKGROUND OF INVENTION

Streaming content, such as movies, videos, virtual meetings, virtual classrooms, security camera feeds, includes content which is distributed “live” (e.g. real time) and which is stored and streamed (e.g. YouTube™, movies on demand, pay-per-view, etc.). In all of these variations of streaming content, a user may consume the content (e.g. watch, listen, etc.) using a variety of output devices, such as a television, a game console, a smart phone, and a variety of types of computer (e.g. desktop, laptop, tablet, etc.).

Typically, if a person is watching such a video and is interested in a subject in the streaming content, such as a particular actor, or a particular geographic location, or a particular vehicle, etc., the person must conduct one or more inquiries separately from the streaming content player. For example, one might have to switch to a search engine application, and enter a question such as “What kind of car did Jason Stratham drive in the second Transporter movie?” or “Who played the love interest in the movie Pride and Prejudice?” or “Where were the street races filmed in the first Fast and Furious movie?”. The first answers received may or may not yield an accurate answer, so more rounds of searching may be necessary. Another approach would be for the consumer to ask his or her friends similar questions, such as by text messaging them or posting a question on a social network while consuming the content.

### SUMMARY OF THE INVENTION

A tool allows a user to identify selections of streaming content such as video, movies, and audio, establishes connections to an input device (stylus, mouse, trackball, a touch screen, etc.) and an output device (smart television, computer screen, etc.) or a streaming content server (on-demand server, cable TV decoder, online radio station, etc.). A user selects a portion of the streaming content such as by tapping or circling a person, place or thing in a video, using the input device, and the selection criteria are used to look up pre-tagged content or to submit to image or audio recognition services. The resulting identification is shown to the user on an output device, and may be instantly shared with collaborators on the same streaming content.

### BRIEF DESCRIPTION OF THE DRAWINGS

The figures presented herein, when considered in light of this description, form a complete disclosure of one or more embodiments of the invention, wherein like reference numbers in the figures represent similar or same elements or steps.

FIG. 1. shows a generalized arrangement of components and their interactions according to at least one embodiment of the present invention.

FIG. 2 sets forth an exemplary logical process according to the present invention.

FIG. 3 depicts a user experience model according to the present invention.

FIG. 4 illustrates a generalized computing platform suitable for combination with program instructions to perform a logical process according to the present invention.

### DETAILED DESCRIPTION OF EMBODIMENT(S) OF THE INVENTION

The present inventors have recognized a problem and opportunity not yet noticed or discovered by those skilled in the relevant arts. In this ever expanding age of visual entertainment and desire for instantaneous answers, streaming content consumers (e.g. viewers, listeners, class attendees, etc.) would benefit from an ability to instantly identify objects they see on the screen with just the touch of their finger, without having to engage an entirely separate set of computer application programs. So, the inventors set out to find an existing process, tool or device which would allow such an intuitive user function within the context of consuming streaming content. Having found none suitable, the inventors then set about defining such a method and system.

### Review of the Available Technologies

The inventors set out to determine if there is available technology to accomplish this functionality, and there appears to be none. The current technology is limited to enabling a user to tag an image with an identity such as a name or place, as is well known in FaceBook™ and other photo sharing social websites. Some of the following technologies available in the art can be incorporated and adapted for use in the present invention, but none that the inventors have found actually solve the problem identified in the foregoing paragraphs.

One example of available face recognition technology can be seen in U.S. pre-grant published patent application 2010/0246906 by Brian Lovell. This describes how face recognition of photographs work, but there is no teaching regarding how to integrate such recognition functions into a user-friendly paradigm for identifying selections within streaming content.

Another pre-grant published U.S. patent application 2004/0042643 by Alan Yeh explains how face recognition works on image capturing devices, but again, there is no teaching regarding how to integrate such recognition functions into a user-friendly paradigm for identifying selections within streaming content.

And, U.S. pre-grant publication 2008/0130960 by Jay Yagnik teaches a system and method for searching for and recognizing images on worldwide web, and how to drop the image into a search bar. However, there is no teaching or suggestion on how a user might be enabled to tap on image on any running content, invoking a search in background while the original content is running, and receiving the result in the side bar by compressing original content with name and more information.

U.S. Pat. No. 8,165,409 to Ritzau, et al., describes a method for object and audio recognition on a mobile device. However, Ritzau does not describe the interaction between a mobile device (iPAD™, smart phone, etc.), as it relates to and interacts with a television set, for example. It does not describe the means and flexibility for interacting with the TV (WiFi, cell Network, Bluetooth), nor does not describe the concept of pre-tagging images and geographic locations for faster subsequent retrieval. There is also no mention of using enabling art that will supplement techniques such as facial recognition by using pre-loaded video where images are previous identified at given times in the feed and can be fetched at will. There was also no mention of collaboration and sharing of the information across multiple “smart” devices. That is to say, if multiple people are watching the same TV and they all have tablets as they sit on the coach, one image may be identified and then shared across the devices such that they can all benefit from the retrieved information.

And, U.S. pre-grant published patent application 2009/0091629 to Robert J. Casey describes a method for pointing a device at a television screen in order to identify an actor. It takes a picture, then compares the image using facial recognition to a database for identification. The invention appears to be limited in scope to only this aspect. There is no mention of identifying geographic locations, or usage of networking to obtain the relevant data and communicate it back to a smart device. It does not suggest pre-tagging for fast loading or time indicators that can be used to identify images and objects at various locations in the feed. There is no mention of sharing the information to multiple users who are watching the same show.

There are other well-known solutions to different problems which, although they do not address the present problem, may be usefully coordinated or integrated with the present invention. One such known solution is a song identification service (Shazam™) which allows a user to capture a portion of an audible song using a microphone on a mobile device (e.g. cell phone, iPod™, etc.), and the service the identifies the song and artist from the captured audio clip. The latest improvements to Shazam provides identification of a streaming content such as the name of a TV show or movie, and it lists the actors in the streaming content, but it does appear not provide a user the ability to select an area of an image and identify the actor, building or product in that area of the image.

Another known domain of solutions are services which can recognize and even replace text words in an image or digital photograph, such as U.S. Pat. No. 8,122,424 (Viktors Berstis, et al., Oct. 3, 2008). However, neither of these solutions provide for a user to select an area of streaming content, capture that area, and then perform facial, geographic, architectural, or product recognition.

### Objectives of the Present Invention

Compared to the available art, embodiments of the present invention provide a collaborative tool for interacting with visual entertainment and with other consumers (users) of that visual entertainment (e.g. streaming content). This has not only entertainment value, but can be applied in an educational aspect, especially relating to the geographic identification, as well as to premise security domains, such as team coordination of identifying people and objects in a controlled physical space. The present invention provides a new interactive model for watching television and other forms of streaming content, utilizing a combination of smart devices, networking, and collaboration to do so.

Embodiments of the present invention can interoperate with a smart device with touch screen capability where a user can select a portion of an image by any mouse, stylus or other pointing device. Then, embodiments of the invention automatically search on the content within the selection to identify a person, a location, a building, or a product (e.g. car, phone, clothing, etc.) within the selection. The identification is then transmitted back to the user, preferably to his or her smart device and optionally to a sidebar area of the television.

For example, an intended operation is when a consumer is watching sports, a movie, or a live broadcast and wants to find out the name of an individual (or actor) in that show or in a movie, embodiments of the present invention will allow the consumer to simply perform a user interface gesture, e.g. tap or circle on an input device's screen, which invokes automatic searching and retrieving of this information in real time. Additionally, if a user sees a monument or geographic feature in what he or she is watching, embodiments of the invention will allow the user to select it (e.g. click on it), and instantly discover the name and location so the user might plan a visit to that monument or location.

Embodiments of the present invention will span the age demographic and can be used by adults looking for the name of an actor, or by students trying to find out the name and location of that neat canyon they just saw on the discovery channel, etc.

Many devices are now interconnected with each other. For example, smart television may be interconnect to a smart phone or a tablet computer using a variety of communication means, such as BlueTooth, WiFi, and InfraRed Data Arrangement (IrDA).

Additional features of various embodiments of the present invention can include:
(a) some streaming content may have pre-tagged images provided by the producer of the content, such as for in-program advertising, which are incorporated into a database and associated with a frame number or time code (e.g. Society of Motion Pictures and Television Engineers timestamps), such that when the same frame is selected by a user, face recognition and image recognition is unnecessary, only indexing and retrieving by the frame number or timestamp need to be performed;
(b) after recognition on a portion of selected content has been completed, these images may be stored in a database associated with the content title and a frame number or timestamp, thus allowing future requests to be handled as in (a); and (c) identified content portions may be instantly shared with other users via social networks, such as FacBook™, Google+™, Pheed™, and Instagram™, optionally including implementing Digital Rights Management (DRM) controls as necessary.

### User Experience Model

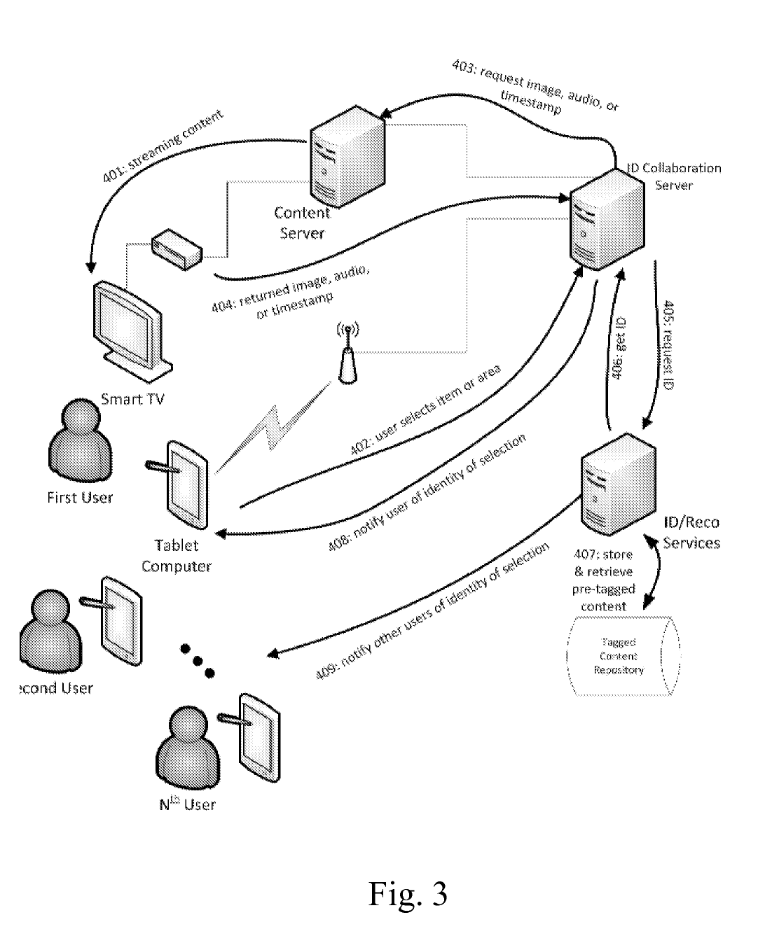

Before describing a plurality of flexible system implementations, we first present a user experience model which is provide by those embodiments. Referring to FIG. 3, while a first user is enjoying streaming content (401) from a content server such as a video-on-demand web service (e.g. YouTube™) or a digital cable television service on a first output device such as a smart TV, the user may engage a second smart device, such as a tablet computer, to select an item (e.g. click on the item) or area (e.g. draw a circle around an area on the display) within the video portion of the streaming content. Methods already exist to allow a smart device such as a tablet computer or smart phone to control a television and to control a cable TV decoder box, so various implementations of the present invention may improve upon that model to accomplish the user input of a selection of a portion (less than all of what is showing) of streaming content.

This selection (402) is then transmitted to an identification collaboration server, such as in the form of a clipped or marked up graphics file, or in the form of an X-Y coordinate set relating to the video player, etc. The selection is received by the identification collaboration server, and it is converted to a request (403) to the content server to identify a timestamp or frame number corresponding to what is currently streaming to the output device, or to gather the graphics or audio clip as selected by the user (if it was not provided by the original selection 402).

The identification collaboration server then receives from the content server a response (404), at which time the identification collaboration server has in its possession some or all of the following: a frame number in which the selection was made, a timestamp corresponding to what was playing at the time the selection was made, a coordinate indicator of a point within the streaming content where the selection was made, and a set of coordinates of points describing a semi-closed periphery around content within the streaming content where the selection was made (e.g. the user selected a point or an area within the streaming content but not all of the streaming content).

The identification collaboration server then queries (405) one or more identification and recognition services, which determines if this particular point, area, frame or timestamp has been previously tagged and previously identified. If so, the previously tagged identification, such as an actor's name, place's name or product's name, is retrieved (407), and returned (406) to the identification collaboration server. If it has not been previously tagged, then one or more recognition services, such as those available in the current art, are invoked to perform facial recognition (identify people), geographic recognition (identify places and buildings), text recognition (identify signs or labels in the image), and audio recognition (identify sounds, words, and music in the content selection).

The results of the one or more invoked recognition services are then returned (406) to the identification collaboration server, and preferably, these new identification tags are stored (407) in the pre-tagged content repository associated with the content source (e.g. movie or video title, song name, etc.), frame number, timestamp value, point in frame and area in frame as appropriate and as available.

The identification collaboration server then notifies the user of the results of the identification effort (408, “identification results”), such as by posting a pop up graphical user interface dialog on the first user's tablet computer (e.g. a call out bubble pointing to the selected content) or such as a thumbnail image of the selected content and the identification results shown in a side bar information area on the smart television, or both, of course.

At this point, one can readily see the user experience model is quite intuitive and streamlined, despite the technical complexities which have been performed during the process. The user simply used his or her input device (smart phone, tablet computer, etc.) to select a point or area within the streaming content, and in real time, received identification of what or who was in that selection.

Further enhancements of certain embodiments of the present invention include the identification collaboration server transmitting the identified portion of streaming content to one or more additional users, preferably in real time, so that other users can engage in a timely social manner with the first user. Thus, a social paradigm is provided to the first user who, when watching or experiencing streaming content, finds something interesting and can instantly share than with one or more friends or colleagues. In a consumer application, the other users may be friends or other users who may also be interested in the same actor, product, or travel destinations. In an education application, the other users may be other students who would learn from the selected content. In a security context, the other users may be other security officers or experts who may be able to use the selected content to further investigate a potential breech in security, theft, attack, or fraud.

Enhanced Recognition and Identification Method. According to additional aspects of some embodiments of the present invention, two additional features are realized. First, multiple recognition services may be queried to identify the portion of captured video. Then, using a weighting or blending algorithm, such as a voting schema, the multiple identification results are combined to yield a conclusion with a certainty indicator. For example, two recognition services respond that a clipped area of video contain actor A, but a third recognition service might respond that it contains actor B. Using a voting or weighting scheme, the results would be determined to be actor A with a 66% certainty.

A second feature that may be optionally realized is using the clipped area, if the input is an area, to find similarly but not exactly matching pre-tagged clipped areas. Most users would not circle the same face or building or product in a video frame in the exact same way, so the areas would not be an exact match. According to this feature, the degree of match of the areas would be used to select a most certain result. If two pre-tagged areas have different percentage of overlapping area when compared to a new area to be identified, then the one with the greatest percentage of overlap might be deemed the most certain identification. Or, there results, if different, might be blended or weighted according to the percentage overlap. For example, if one pre-tagged image of actor A has 77% overlap, and another pre-tagged image actor B has a 28% overlap, then the results might be [0.77/(0.77+28)]=73% certain it's actor A, and [0.28/(0.77+0.28)]=26% certain it's actor B. As such, some embodiments may generate a confidence level it the identification, which may be communicated to the user in a useful manner such as a number, or an icon, etc.

### Generalized Arrangement of Components

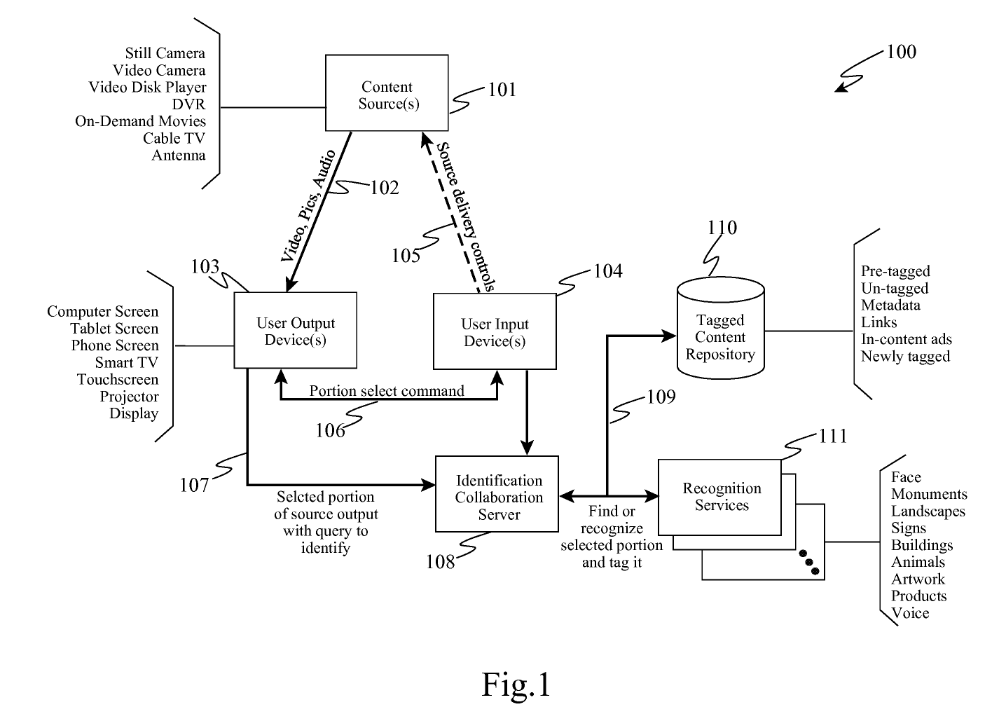

Referring to FIG. 1, a more generalized system diagram (100) is shown which corresponds to and enables the user experience model of FIG. 3. In this system diagram, the content source (101) may be any combination of one or more of a still camera (e.g. instantly accessed photos), a video camera (e.g. live video capture), a video disk player (e.g. BlueRay™, DVD, VHS, Beta™, etc.), a digital video recorder (e.g. TiVo™, on-demand movies and show segments, etc.), a cable television decoder box, or a broadcast reception antenna. Thus, streaming content (102) shall refer to any combination of one or more of the output from these content sources, such as digital video, digital photographs, and digital audio, and potentially including multi-media content such as online classes, online meetings and online presentations in which one or more graphical components (video, slides, photos, etc.) are delivered (e.g. streamed) in a time-coordinated fashion with one or more audible components (music, voice, narration, etc.).

This streamed content (102) is received by any combination of one or more user output devices (103) which may include a desktop computer display, a table computer screen, a smart telephone screen, a television, a touch-sensitive display such as found on some appliance and special purpose kiosks, and a video projector. The user may engage any combination of one or more user input devices (104) to make his or her selection within the streaming content, including a stylus, a mouse, a trackball, a joystick, a keyboard, a touch-sensitive screen, and a voice command.

The tagged content repository (110) may store any combination of one or more data items including pre-tagged portions of content (e.g. pre-tagged photos, videos and audio), untagged portions of content (e.g. content which may be subjected to recognition by human operators or machine recognition at a later time), metadata regarding tagged and untagged content, hyperlinks associated with tagged content, additional content which may be selectively streamed associated with tagged content (e.g. in-program commercials, pop-up help audio or video, etc.), and newly tagged content (e.g. queued for quality control verification to remove or mark objectionable content, to review for digital rights management, etc.).

The identification collaboration server (108) (e.g. controller) may be a web server or computing platform of a variety of known forms, including but not limited to rack-mounted servers, desktop computers, embedded processors, and cloud-based computing infrastructures. The recognition services (111) may include any combination of one or more of readily available services including recognition services for faces, monuments, buildings, landscapes, signs, animals, works of art, and products (e.g. actors, politicians, wanted persons, missing persons, passers-by, vehicles, foods, furniture, clothing, jewelry, hotels, beaches, mountains, museums, government buildings, places of worship, travel destinations, etc.).

### Example Logical Process

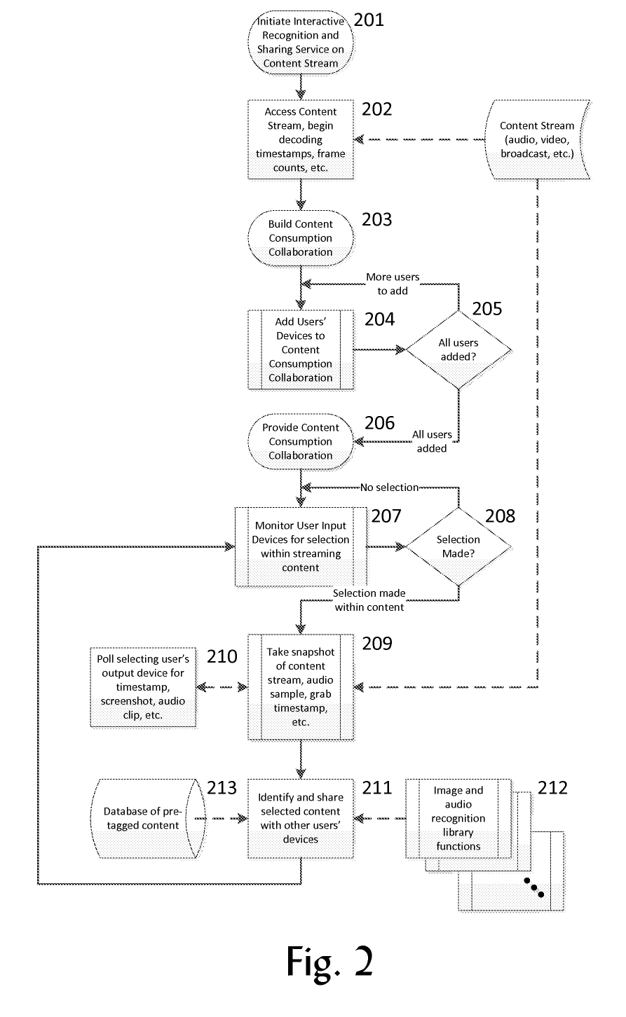

Referring now to FIG. 2, an exemplary logical process according to the present invention is shown. This particular process begins (201) by initiating an interactive identification and sharing service on a particular stream of content. So, in some embodiments, the content stream itself will be accessed (202) which enables the system to directly capture or “grab” frames of video or clips of audio data.

Next, if more than one user is to collaborate, the group of users (203) is built such as by finding currently online friends in a friends list (or in a colleagues or team list), and optionally by contacting one or more friends or colleagues who are not currently logged into the system or online (e.g. by paging, text messaging, electronic mailing, or calling).

After each user is discovered, contacted, or logged into the collaborative session (204, 205), then the service to collect selections of streaming content from the one or more users is initiated (206) by coordinating any combination of one or more of an application running on a pervasive computing device (e.g. tablet computer, e-reader, smart phone, smart appliance, etc.), a computer human interface device (e.g. keyboard, mouse, trackball, trackpad, stylus, etc.), and a voice command input (e.g. headset, microphone, etc.).

The system then waits and monitor (207, 208) until one or more of the users make an selection within the streaming content, which can be any combination of one or more of a coordinate point within the content stream (e.g. an X-Y coordinate where the user tapped), a set of coordinate points (e.g. a set of X-Y coordinates which circumscribe a semi-closed area in the content around which the user drew a line), a timestamp (e.g. at which time during the stream the user selected), a frame number (e.g. in which the user selected), and a voice command (e.g. “identity that man”, “identify that car”, “identify that place”, etc.)

Responsive to the selection being made and received, if the stream was accessed (202), then the service may extract (209) a clip of audio, video, or both, at the frame, timestamp, coordinate or area indicated by the received selection indication. If the stream was not accessed (e.g. the identification collaboration server does not have access to the streaming content), then the user's output device such as a smart TV or computer video client application may be polled (210) to obtain one or more of the additional selection criteria.

Next, the collected selection criteria are provided (211) to one or more databases (213) to determine if this content has been tagged before, and if so, to retrieve the identification information. If it has not been tagged before, or if further identification clarity or confirmation is desired, the this information can be provided to one or more recognition services (212) such as face, voice, word, building, landscape, and product recognizer services. As the present invention provides a framework of interaction and cooperation between all of the previously-mentioned components, it is envisioned that additional recognition services can be coopted from the art as they are currently available and as they become available, using discovery and remote invocation protocols such as Common Object Request Bus Architecture (CORBA), remote procedure call (RPC), and various cloud computing application programming interfaces (API).

### Suitable Computing Platform

The preceding paragraphs have set forth example logical processes according to the present invention, which, when coupled with processing hardware, embody systems according to the present invention, and which, when coupled with tangible, computer readable memory devices, embody computer program products according to the related invention.

Regarding computers for executing the logical processes set forth herein, it will be readily recognized by those skilled in the art that a variety of computers are suitable and will become suitable as memory, processing, and communications capacities of computers and portable devices increases. In such embodiments, the operative invention includes the combination of the programmable computing platform and the programs together. In other embodiments, some or all of the logical processes may be committed to dedicated or specialized electronic circuitry, such as Application Specific Integrated Circuits or programmable logic devices.

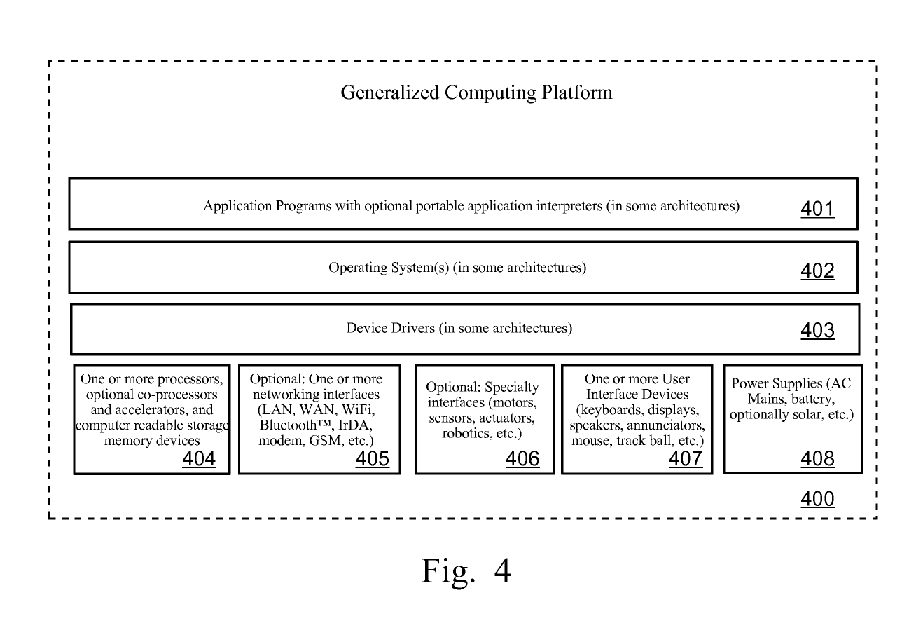

The present invention may be realized for many different processors used in many different computing platforms. FIG. 4 illustrates a generalized computing platform (400), such as common and well-known computing platforms such as “Personal Computers”, web servers such as an IBM iSeries™ server, and portable devices such as personal digital assistants and smart phones, running a popular operating systems (402) such as Microsoft™ Windows™ or IBM™ AIX™, UNIX, LINUX, Google Android™, Apple iOS™, and others, may be employed to execute one or more application programs to accomplish the computerized methods described herein. Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (401) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (404) accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces (405) may be provided, as well as specialty interfaces for specific applications. If the computing platform is intended to interact with human users, it is provided with one or more user interface devices (407), such as display(s), keyboards, pointing devices, speakers, etc. And, each computing platform requires one or more power supplies (battery, AC mains, solar, etc.).

### CONCLUSION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should also be recognized by those skilled in the art that certain embodiments utilizing a microprocessor executing a logical process may also be realized through customized electronic circuitry performing the same logical process(es).

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. A method for identifying selections of streaming content comprising:
establishing a first connection by a computing platform with at least one user input device having a user-operated selection means for selecting a portion of displayed visual streaming content;
establishing at least second connection by a computing platform to a user output device and optionally a third connection to a visual streaming content server;
receiving by a computing platform from the user input device a selection of a portion less than all of the visual streaming content currently streaming to the at least one user output device;
via the second or third connection, collecting by a computing platform one more selection criteria corresponding to the visual portion selected;
submitting by a computing platform the one or more selection criteria to one or more identification services;
receiving from the identification services by a computing platform one or more identification results corresponding to the submitted selection criteria;
sending by a computing platform to the user output device the identification results; and
displaying to the user the identification results.

2. The method as set forth in claim 1 wherein the user input device is selected from the group consisting of a stylus, a mouse, a trackball, a joystick, a keyboard, a touch-sensitive screen, a microphone and a voice command recognizer.

3. The method as set forth in claim 1 wherein the user output device is selected from the group consisting of a desktop computer display, a table computer screen, a smart telephone screen, a smart television, a touch-sensitive display, and a video projector.

4. The method as set forth in claim 1 wherein the streaming content server is selected from the group consisting of an on-demand movie server, an on-demand video server, a computer, a cable television decoder, a game console, a digital video recorder, a video disk player, a satellite video service, an audio streaming service, a virtual radio station, a personal audio player and a satellite audio service.

5. The method as set forth in claim 1 wherein the portion is selected from the group consisting of a video frame number, a timestamp, a screen coordinate of a point selection, a set of screen coordinates of an area selection, an audio segment and an image portion.

6. The method as set forth in claim 1 wherein the one or more identification services is selected from the group consisting of a database of pre-tagged audio, a database of pre-tagged video, a database of pre-tagged photographs, a facial recognition service, a landscape recognition service, a building recognition service, a voice recognition service, a product recognition service, and a song recognition service.

7. The method as set forth in claim 1 wherein the sending of the identification results comprises causing an information sidebar to be shown on a user output device.

8. The method as set forth in claim 1 wherein the sending of the identification results comprises causing pop-up information box to be shown on a user output device.

9. The method as set forth in claim 1 wherein the second connection comprises accessing streaming content being presented on user output device, and wherein the collecting one more selection criteria comprises extracting a portion of the streaming content corresponding to one or more of a frame number, a timestamp, a screen coordinate point and a screen area circumscribed by a set of coordinate points, and wherein the submitting of selection criteria to an identification service comprises submitting the extracted portion of content.

10. The method as set forth in claim 8 wherein the extracted portion of the streaming content comprises at least one content type selected from the group consisting of a video clip and a cropped photograph.

11. The method as set forth in claim 1 further comprising registering by a computing platform a plurality of user output devices associated with a commonly consumed streaming content, and wherein the sending of the identification results further comprises sending to the plurality of registered user devices.

12. A computer program product for identifying selections of streaming content, said computer program product comprising:
a computer readable storage medium having encoded or stored thereon:
first program instructions executable by a computing device to cause the device to establish a first connection by a computing platform with at least one user input device having a user-operated selection means for selecting a portion of displayed visual streaming content;
second program instructions executable by a computing device to cause the device to establish at least second connection by a computing platform to a user output device and optionally a third connection to a visual streaming content server;
third program instructions executable by a computing device to cause the device to receive by a computing platform from the user input device a selection of a portion less than all of the visual streaming content currently streaming to the at least one user output device;
fourth program instructions executable by a computing device to cause the device to, via the second or third connection, collect by a computing platform one more selection criteria corresponding to the visual portion selected;
fifth program instructions executable by a computing device to cause the device to submit by a computing platform the one or more selection criteria to one or more identification services;
sixth program instructions executable by a computing device to cause the device to receive from the identification services by a computing platform one or more identification results corresponding to the submitted selection criteria;
seventh program instructions executable by a computing device to cause the device to send by a computing platform to the user output device the identification results; and
eighth program instructions executable by a computing device to cause the device to display to the user the identification results.

13. The computer program product as set forth in claim 12 wherein the user input device is selected from the group consisting of a stylus, a mouse, a trackball, a joystick, a keyboard, a touch-sensitive screen, a microphone and a voice command recognizer, wherein the user output device is selected from the group consisting of a desktop computer display, a table computer screen, a smart telephone screen, a smart television, a touch-sensitive display, and a video projector, wherein the streaming content server is selected from the group consisting of an on-demand movie server, an on-demand video server, a computer, a cable television decoder, a game console, a digital video recorder, a video disk player, a satellite video service, an audio streaming service, a virtual radio station, a personal audio player and a satellite audio service, wherein the portion is selected from the group consisting of a video frame number, a timestamp, a screen coordinate of a point selection, a set of screen coordinates of an area selection, an audio segment and an image portion, wherein the identification service is selected from the group of consisting of a database of pre-tagged audio, a database of pre-tagged video, a database of pre-tagged photographs, a facial recognition service, a landscape image recognition service, a building image recognition service, a product image recognition service, and a song recognition service, and wherein the sending of the identification results comprises one or more actions selected from the group comprising causing an information sidebar to be shown on a user output device and causing pop-up information box to be shown on a user output device.

14. The computer program product as set forth in claim 12 wherein the second connection comprises a connection to streaming content being presented on user output device, and wherein the collecting one more selection criteria comprises extracting a portion of the streaming content corresponding to one or more of a frame number, a timestamp, a screen coordinate point and a screen area circumscribed by a set of coordinate points, and wherein the submitting of selection criteria to an identification service comprises submitting the extracted portion of content.

15. The computer program product as set forth in claim 12 further comprising ninth program instructions executable by a computing device to cause the device to register a plurality of user output devices associated with a commonly consumed streaming content, and wherein the program instructions for sending of the identification results further comprises program instructions for sending to the plurality of registered user devices.

16. A system for identifying selections of streaming content, said computer program product comprising:
a computing platform having a processor;
a computer readable storage medium readable by the processor and having encoded or stored thereon:
first program instructions executable by the processor to cause the computing platform to establish a first connection by a computing platform with at least one user input device having a user-operated selection means for selecting a portion of displayed visual streaming content;
second program instructions executable by the processor to cause the computing platform to establish at least second connection by a computing platform to a user output device and optionally a third connection to a visual streaming content server;
third program instructions executable by the processor to cause the computing platform to receive by a computing platform from the user input device a selection of a portion less than all of the visual streaming content currently streaming to the at least one user output device;
fourth program instructions executable by the processor to cause the computing platform to, via the second or third connection, collect by a computing platform one more selection criteria corresponding to the visual portion selected;
fifth program instructions executable by the processor to cause the computing platform to submit by a computing platform the one or more selection criteria to one or more identification services;
sixth program instructions executable by the processor to cause the computing platform to receive from the identification services by a computing platform one or more identification results corresponding to the submitted selection criteria;
seventh program instructions executable by the processor to cause the computing platform to send by a computing platform to the user output device the identification results; and
eighth program instructions executable by the processor to cause the computing platform to display to the user the identification results.

17. The system as set forth in claim 16 wherein the user input device is selected from the group consisting of a stylus, a mouse, a trackball, a joystick, a keyboard, a touch-sensitive screen, a microphone and a voice command recognizer, wherein the user output device is selected from the group consisting of a desktop computer display, a table computer screen, a smart telephone screen, a smart television, a touch-sensitive display, and a video projector, wherein the streaming content server is selected from the group consisting of an on-demand movie server, an on-demand video server, a computer, a cable television decoder, a game console, a digital video recorder, a video disk player, a satellite video service, an audio streaming service, a virtual radio station, a personal audio player and a satellite audio service, wherein the portion is selected from the group consisting of a video frame number, a timestamp, a screen coordinate of a point selection, a set of screen coordinates of an area selection, an audio segment and an image portion, wherein the identification service is selected from the group of consisting of a database of pre-tagged audio, a database of pre-tagged video, a database of pre-tagged photographs, a facial recognition service, a landscape image recognition service, a building image recognition service, a product image recognition service, and a song recognition service, and wherein the sending of the identification results comprises one or more actions selected from the group comprising causing an information sidebar to be shown on a user output device and causing pop-up information box to be shown on a user output device.

18. The system as set forth in claim 16 wherein the second connection comprises a connection to streaming content being presented on user output device, and wherein the collecting one more selection criteria comprises extracting a portion of the streaming content corresponding to one or more of a frame number, a timestamp, a screen coordinate point and a screen area circumscribed by a set of coordinate points, and wherein the submitting of selection criteria to an identification service comprises submitting the extracted portion of content.

19. The system as set forth in claim 16 further comprising ninth program instructions executable by the processor to cause the computing platform to register a plurality of user output devices associated with a commonly consumed streaming content, and wherein the program instructions for sending of the identification results further comprises program instructions for sending to the plurality of registered user devices.
